(19) United States
(12) Patent Application Publication
(10) Pub. No.: US 2025/0284088 A1
(43) Pub. Date: Sep. 11, 2025

(54) OPTICAL ELEMENT DRIVING MECHANISM

(71) Applicant: TDK TAIWAN CORP., Taoyuan City (TW)

(72) Inventors: Yung-Yun CHEN, Taoyuan City (TW); Yi-Ho CHEN, Taoyuan City (TW); Chia-Che WU, Taoyuan City (TW); Jui-Che MENG, Taoyuan City (TW)

(21) Appl. No.: 19/073,321

(22) Filed: Mar. 7, 2025

Related U.S. Application Data
(60) Provisional application No. 63/562,767, filed on Mar. 8, 2024.

(51) Int. Cl. G02B 7/08

(52) U.S. Cl. CPC G02B 7/08

(57) ABSTRACT

An optical element driving mechanism is provided and includes a fixed assembly, a movable part and a driving assembly. The movable part is configured to connect an optical element, and the movable part is movable relative to the fixed assembly. The driving assembly is configured to drive the movable part to move relative to the fixed assembly. The fixed assembly includes an accommodating space configured to accommodate the optical element.

### CROSS REFERENCE TO RELATED APPLICATIONS

This application claims the benefit of U.S. Provisional Application No. 63/562,767, filed on Mar. 8, 2024, the entirety of which is incorporated by reference herein.

### BACKGROUND OF THE INVENTION

### Field of the Disclosure

The present disclosure relates to an optical element driving mechanism, and in particular it relates to an optical element driving mechanism capable of stably driving a camera lens.

### Description of the Related Art

As technology has developed, many of today's electronic devices (such as smartphones) have a camera or video functionality. Using the camera modules disposed on electronic devices, users can operate their electronic devices to capture photographs and record videos.

Today's design of electronic devices continues to follow the trend of miniaturization, meaning that the various components of the camera module or its structure must also be continuously reduced, so as to achieve miniaturization. In general, a driving mechanism in the camera module has a camera lens holder configured to hold a camera lens, and the driving mechanism can have the functions of auto focusing or optical image stabilization. However, although the existing driving mechanism can achieve the aforementioned functions of photographing or video recording, they still cannot meet all the needs of the users.

Therefore, how to design a camera module capable of being disposed on the front side or the rear side of an electronic device and capable of achieving miniaturization are topics nowadays that need to be discussed and solved.

### BRIEF SUMMARY OF THE INVENTION

Accordingly, one objective of the present disclosure is to provide an optical element driving mechanism to solve the above problems.

According to some embodiments of the disclosure, an optical element driving mechanism is provided and includes a fixed assembly, a movable part and a driving assembly. The movable part is configured to connect an optical element, and the movable part is movable relative to the fixed assembly. The driving assembly is configured to drive the movable part to move relative to the fixed assembly. The fixed assembly includes an accommodating space configured to accommodate the optical element.

According to some embodiments, the fixed assembly has an outer cover and a base. The outer cover is fixedly connected to the base along a main axis to form the accommodating space. The optical element driving mechanism further includes a guiding assembly which is configured to guide the movable part to move along a first axis. The first axis is perpendicular to the main axis. The guiding assembly has a first guiding element and a second guiding element, which extend along the first axis and are configured to guide the movable part. When viewed along the main axis, the first guiding element and the second guiding element are respectively located at a first side and a second side of the movable part. When viewed along the main axis, the first guiding element and the second guiding element are arranged along a second axis. The second axis is perpendicular to the first axis. The movable part has a first guiding groove and a second guiding groove, which are configured to respectively accommodate the first guiding element and the second guiding element. When viewed along the first axis, the first guiding groove has a V-shaped structure, and the first guiding element has a circular structure. When viewed along the first axis, the second guiding groove has a U-shaped structure, and the second guiding element has a circular structure.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a three-dimensional schematic diagram of an optical element driving mechanism 100 according to an embodiment of the present disclosure.

FIG. 2 is an exploded diagram of the optical element driving mechanism 100 according to an embodiment of the present disclosure.

FIG. 3 is a cross-sectional view of the optical element driving mechanism 100 along the line A-A in FIG. 1 according to an embodiment of the present disclosure.

FIG. 4 is a three-dimensional view of a partial structure of the optical element driving mechanism 100 in another view according to an embodiment of the present disclosure.

FIG. 5 is a top view of a partial structure of the optical element driving mechanism 100 according to an embodiment of the present disclosure.

FIG. 6 is a side view of a partial structure of the optical element driving mechanism 100 according to an embodiment of the present disclosure.

FIG. 7A is a side view of a partial structure of the optical element driving mechanism 100 in another view according to an embodiment of the present disclosure.

FIG. 7B is a side view of a partial structure of the optical element driving mechanism 100 in another view according to another embodiment of the present disclosure

FIG. 8 is a side view of a partial structure of the optical element driving mechanism 100 according to another embodiment of the present disclosure.

FIG. 9 is a side view of a partial structure of the optical element driving mechanism 100 according to another embodiment of the present disclosure.

FIG. 10 is a perspective view of a partial structure of the optical element driving mechanism 100 according to another embodiment of the present disclosure.

FIG. 11 is a top view of a partial structure of the optical element driving mechanism 100 according to an embodiment of the present disclosure.

### DETAILED DESCRIPTION OF THE INVENTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are in direct contact, and may also include embodiments in which additional features may be disposed between the first and second features, such that the first and second features may not be in direct contact.

In addition, the present disclosure may repeat reference numerals and/or letters in the various examples. This repetition is for the purpose of simplicity and clarity and does not in itself dictate a relationship between the various embodiments and/or configurations discussed. Moreover, the formation of a feature on, connected to, and/or coupled to another feature in the present disclosure that follows may include embodiments in which the features are in direct contact, and may also include embodiments in which additional features may be disposed interposing the features, such that the features may not be in direct contact. In addition, spatially relative terms, for example, “vertical,” “above,” “over,” “below,”, “bottom,” etc. as well as derivatives thereof (e.g., “downwardly,” “upwardly,” etc.) are used in the present disclosure for ease of description of one feature's relationship to another feature. The spatially relative terms are intended to cover different orientations of the device, including the features.

Unless defined otherwise, all technical and scientific terms used herein have the same meaning as commonly understood by one of ordinary skill in the art to which this disclosure belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

Use of ordinal terms such as “first”, “second”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

In addition, in some embodiments of the present disclosure, terms concerning attachments, coupling and the like, such as “connected” and “interconnected”, refer to a relationship wherein structures are secured or attached to one another either directly or indirectly through intervening structures, as well as both movable or rigid attachments or relationships, unless expressly described otherwise.

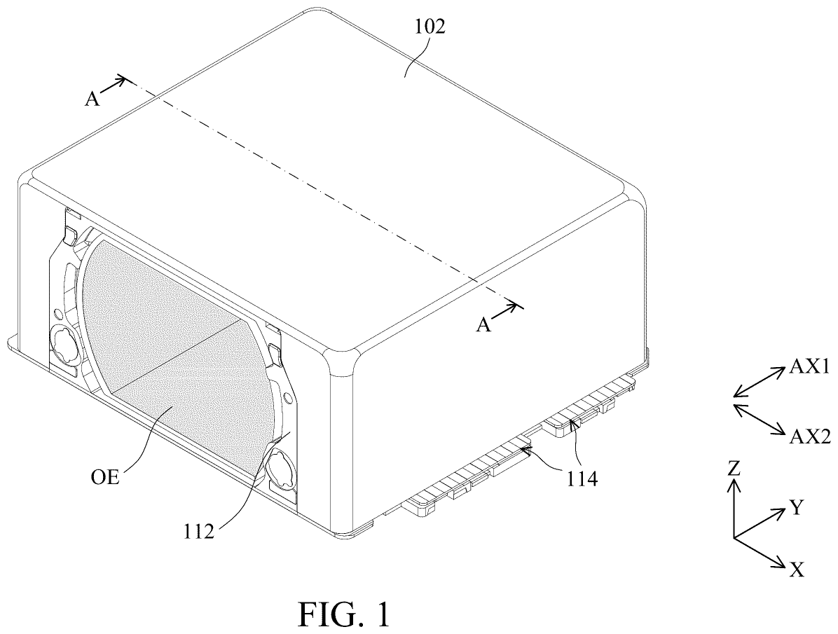

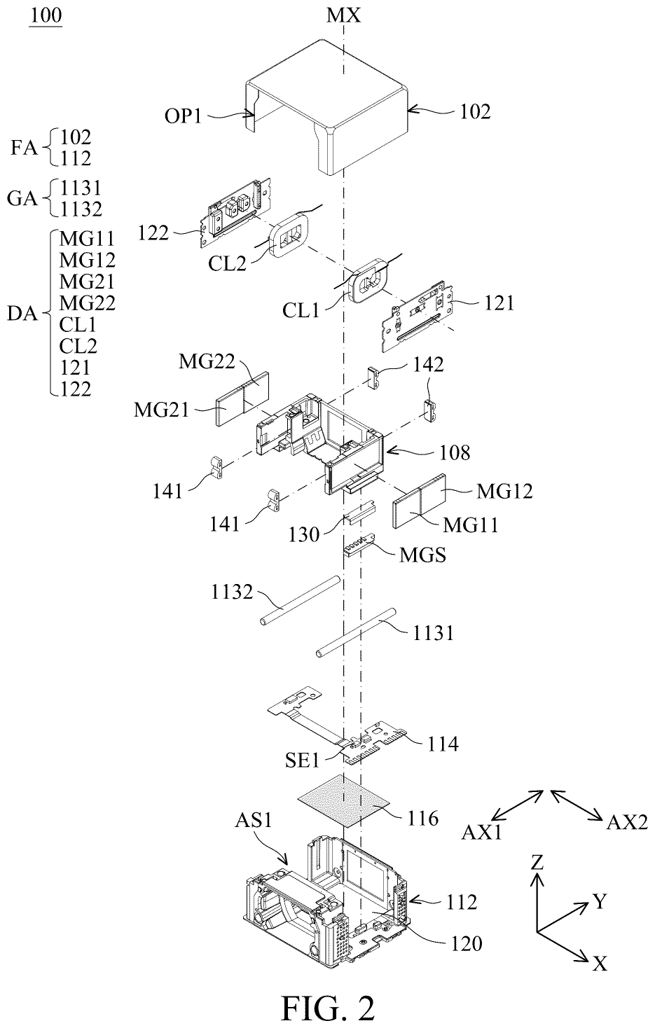

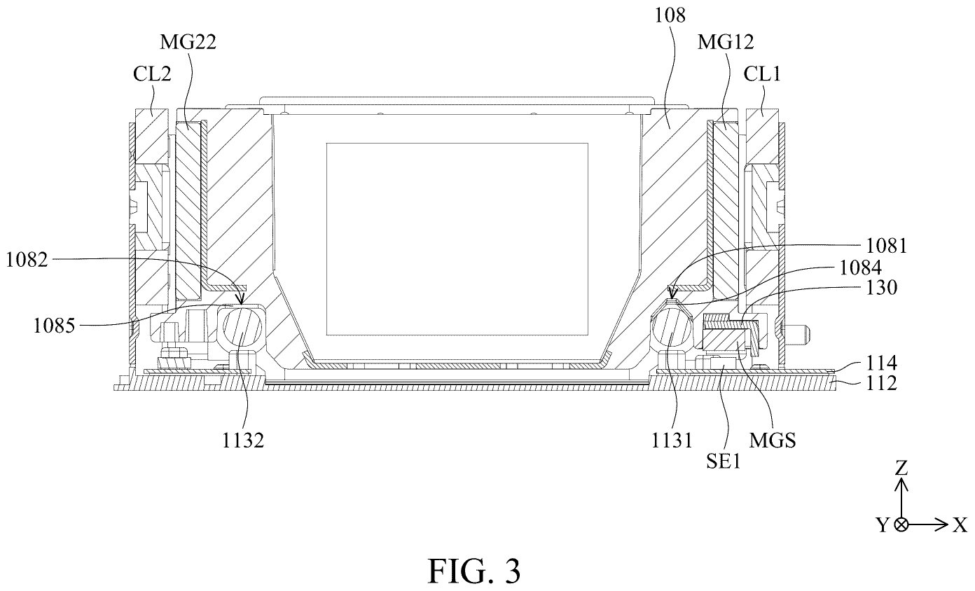

Please refer to FIG. 1 to FIG. 3, FIG. 1 is a three-dimensional schematic diagram of an optical element driving mechanism 100 according to an embodiment of the present disclosure, FIG. 2 is an exploded diagram of the optical element driving mechanism 100 according to an embodiment of the present disclosure, and FIG. 3 is a cross-sectional view of the optical element driving mechanism 100 along the line A-A in FIG. 1 according to an embodiment of the present disclosure. The optical element driving mechanism 100 may be an optical camera module which is configured to carry and drive an optical element OE.

The optical element driving mechanism 100 can be installed in various electronic devices or portable electronic devices, such as a smartphone, to allow users to perform image capture functions. In this embodiment, the optical element driving mechanism 100 is a voice coil motor (VCM) with an auto focus (AF) function, but the disclosure is not limited thereto. In other embodiments, the optical element driving mechanism 100 may also have auto focus (AF) and optical image stabilization (OIS) functions.

As shown in FIG. 2, the optical element driving mechanism 100 includes a fixed assembly FA, a movable part 108, and a driving assembly DA. The movable part 108 is configured to be connected to the aforementioned optical element OE, and the movable part 108 is movable relative to the fixed assembly FA. The driving assembly DA is configured to drive the movable part 108 to move relative to the fixed assembly FA.

In this embodiment, as shown in FIG. 1 and FIG. 2, the fixed assembly FA includes an outer cover 102 and a base 112, and the outer cover 102 is fixedly connected to the base 112 along a main axis MX to form an accommodating space AS1 to accommodate the optical element OE. The outer cover 102 may have a first opening OP1, and when viewed along the main axis MX, the optical element OE is exposed from the first opening OP1. The optical element OE may be an optical lens, but it is not limited thereto.

The optical element driving mechanism 100 may further include a guiding assembly GA which is configured to guide the movable part 108 to move along a first axis AX1, and the first axis AX1 is perpendicular to the main axis MX. Specifically, the guiding assembly GA may have a first guiding element 1131 and a second guiding element 1132 which extend along the first axis AX1 and are configured to guide the movable part 108.

In this embodiment, as shown in FIG. 2, the driving assembly DA may include a first magnetic element MG11, a second magnetic element MG12, and a first coil CL1. The first magnetic element MG11 and the second magnetic element MG12 are fixedly disposed on the movable part 108, and the first coil CL1 is disposed on the base 112 and corresponds to the first magnetic element MG11 and the second magnetic element MG12.

Similarly, the driving assembly DA may further include a third magnetic element MG21, a fourth magnetic element MG22, and a second coil CL2. The third magnetic element MG21 and the fourth magnetic element MG22 are fixedly disposed on the movable part 108, and the second coil CL2 is disposed on the base 112 and corresponds to the third magnetic element MG21 and the fourth magnetic element MG22.

Specifically, the driving assembly DA may further include a first electrical connection assembly 121 and a second electrical connection assembly 122, the first coil CL1 is disposed on the base 112 by the first electrical connection assembly 121, and the second coil CL2 is disposed on the base 112 by the second electrical connection assembly 122. Furthermore, the optical element driving mechanism 100 may further include a circuit assembly 114 which is fixedly disposed on the base 112.

In this embodiment, the circuit assembly 114 may be a printed circuit board, and the first electrical connection assembly 121 and the second electrical connection assembly 122 may be plastic plates in which metal circuits may be embedded using insert molding technology so as to electrically connect to the circuit assembly 114, but they are is not limited thereto.

That is, the first coil CL1 and the second coil CL2 are fixedly disposed on the first electrical connection assembly 121 and the second electrical connection assembly 122 respectively, so as to be electrically connected to the circuit assembly 114 through the first electrical connection assembly 121 and the second electrical connection assembly 122.

When the first coil CL1 and the second coil CL2 are energized, the first coil CL1, the first magnetic element MG11, and the second magnetic element MG12 can generate a first electromagnetic driving force, the second coil CL2, the third magnetic element MG21, and the fourth magnetic element MG22 can generate a second electromagnetic driving force, and the first electromagnetic driving force and the second electromagnetic driving force can cooperatively drive the movable part 108 and the optical element OE to move back and forth along the first axis AX1 to achieve the purpose of autofocus.

In addition, as shown in FIG. 2 and FIG. 3, the optical element driving mechanism 100 may further include a first sensing element SE1 and a sensing magnet MGS. The first sensing element SE1 and the sensing magnet MGS are disposed on the circuit assembly 114 and the movable part 108 respectively. The first sensing element SE1 is configured to sense the magnetic field change of the sensing magnet MGS so as to sense the position of the movable part 108.

In this embodiment, the first sensing element SE1 is, for example, a Hall sensor or a tunnel magneto-resistive sensor (TMR sensor), but it is not limited thereto. Furthermore, in this embodiment, the optical element driving mechanism 100 further includes a protective element 130 which is disposed between the movable part 108 and the sensing magnet MGS. The protective element 130 is configured to cover a portion of the sensing magnet MGS.

As shown in FIG. 3, when viewed along the main axis MX, the protective element 130 has an L-shaped structure and is made of, for example, a magnetically conductive material. Based on the configuration of the protective element 130, the interference of the aforementioned other magnetic elements (magnets) on the sensing magnet MGS can be avoided, thereby increasing the accuracy of position sensing.

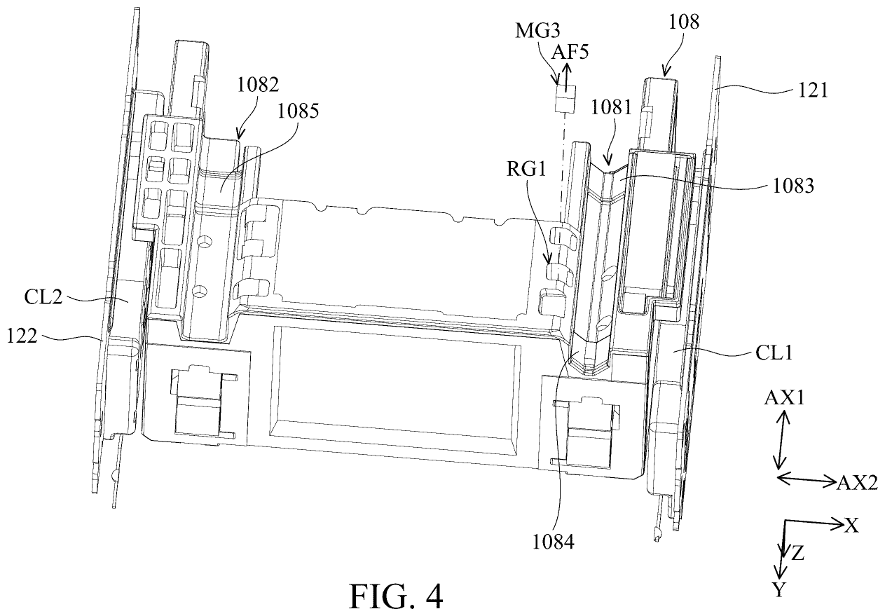

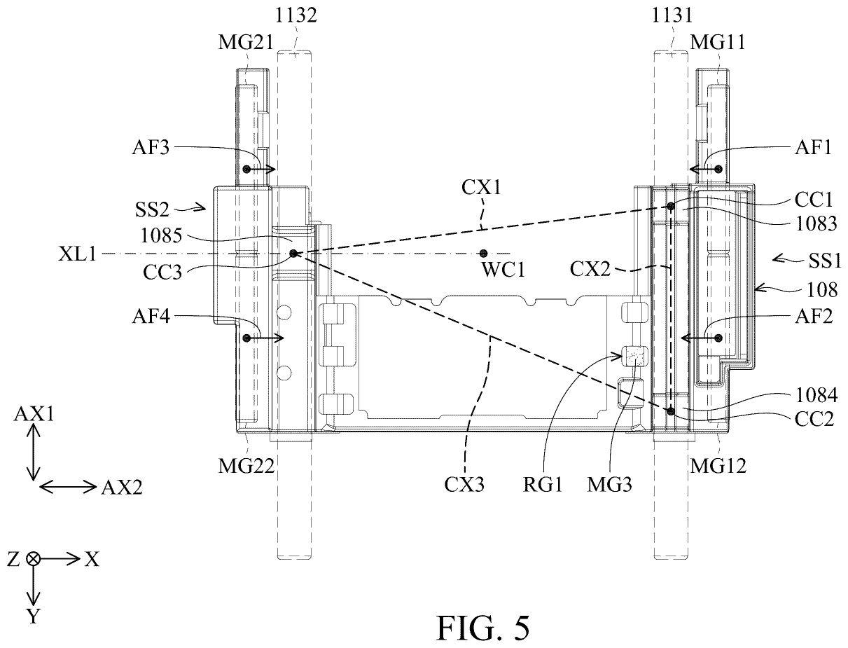

Next, please refer to FIG. 1 to FIG. 5. FIG. 4 is a three-dimensional view of a partial structure of the optical element driving mechanism 100 in another view according to an embodiment of the present disclosure, and FIG. 5 is a top view of a partial structure of the optical element driving mechanism 100 according to an embodiment of the present disclosure. As shown in FIG. 5, when viewed along the main axis MX, the first guiding element 1131 and the second guiding element 1132 are located at a first side SS1 and a second side SS2 of the movable part 108, respectively.

When viewed along the main axis MX, the first guiding element 1131 and the second guiding element 1132 are arranged along a second axis AX2, and the second axis AX2 is perpendicular to the first axis AX1. In this embodiment, as shown in FIG. 4 and FIG. 5, the movable part 108 may have a first guiding groove 1081 and a second guiding groove 1082, which are configured to respectively accommodate the first guiding element 1131 and the second guiding element 1132.

As shown in FIG. 3, when viewed along the first axis AX1 (the Y-axis), the first guiding groove 1081 has a V-shaped structure, and the first guiding element 1131 has a circular structure, but they are not limited thereto. When viewed along the first axis AX1, the second guiding groove 1082 has a U-shaped structure, and the second guiding element 1132 has a circular structure, but they are not limited thereto.

Furthermore, as shown in FIG. 4 and FIG. 5, the movable part 108 further includes a first contact portion 1083 and a second contact portion 1084 which are disposed in the first guiding groove 1081, and the first contact portion 1083 and the second contact portion 1084 are, for example, protruding structures configured to be in contact with the first guiding element 1131.

Similarly, the movable part 108 may further include a third contact portion 1085 which is disposed in the second guiding groove 1082, and the third contact portion 1085 is, for example, a protruding structure configured to be in contact with the second guiding element 1132.

As shown in FIG. 5, the first contact portion 1083 may define as a first contact center CC1, the second contact portion 1084 may define as a second contact center CC2, and the third contact portion 1085 may define as a third contact center CC3. When viewed along the main axis MX, the first contact center CC1 and the third contact center CC3 can define a first central connecting line CX1, which is neither parallel nor perpendicular to the first axis AX1.

Furthermore, when viewed along the main axis MX, the first contact center CC1 and the second contact center CC2 define a second central connecting line CX2, which is substantially parallel to the first axis AX1. When viewed along the main axis MX, the third contact center CC3 and the second contact center CC2 define a third central connecting line CX3, which is neither parallel nor perpendicular to the first axis AX1.

As shown in FIG. 5, when viewed along the main axis MX, the first central connecting line CX1, the second central connecting line CX2 and the third central connecting line CX3 can together form a triangle. It is worth noting that this triangle is not a non-isosceles triangle. That is, the length of the first central connecting line CX1 is not equal to the length of the third central connecting line CX3.

Furthermore, as shown in FIG. 5, the first magnetic element MG11 and the second magnetic element MG12 are located at the first side SS1, and the third magnetic element MG21 and the fourth magnetic element MG22 are located at the second side SS2. It is worth noting that the first guiding element 1131 and the second guiding element 1132 are made of magnetic conductive material.

Therefore, the first magnetic element MG11 and the second magnetic element MG12 are configured to act with the first guiding element 1131 to respectively generate a first magnetic attraction force AF1 and a second magnetic attraction force AF2. When viewed along the main axis MX, the first magnetic attraction force AF1 and the second magnetic attraction force AF2 are located on opposite sides of the first contact center CC1.

Similarly, the third magnetic element MG21 and the fourth magnetic element MG22 are configured to act with the second guiding element 1132 to respectively generate a third magnetic attraction force AF3 and a fourth magnetic attraction force AF4. When viewed along the main axis MX, the third magnetic attraction force AF3 and the fourth magnetic attraction force AF4 are located on opposite sides of the third contact center CC3.

It is worth noting that the projection of the second magnetic attraction force AF2 along the second axis AX2 falls on the second central connecting line CX2, while the projection of the first magnetic attraction force AF1 along the second axis AX2 does not fall on the second central connecting line CX2, and the second magnetic attraction force AF2 is greater than the first magnetic attraction force AF1.

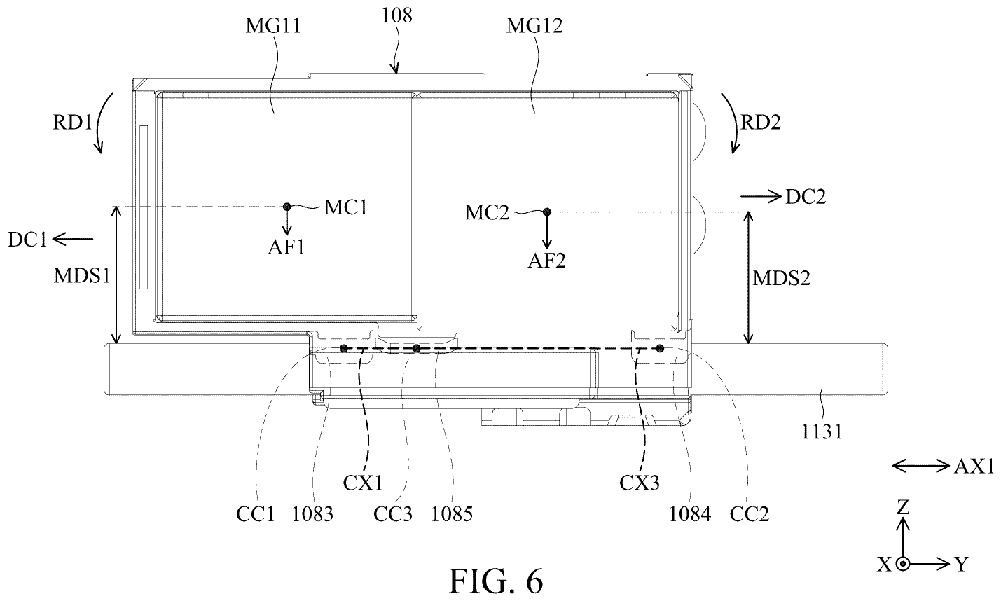

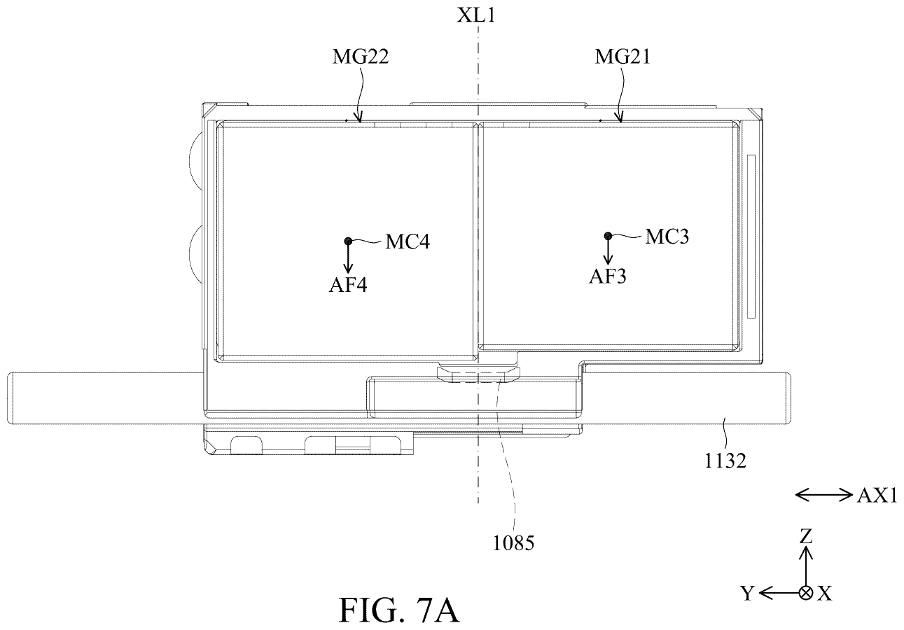

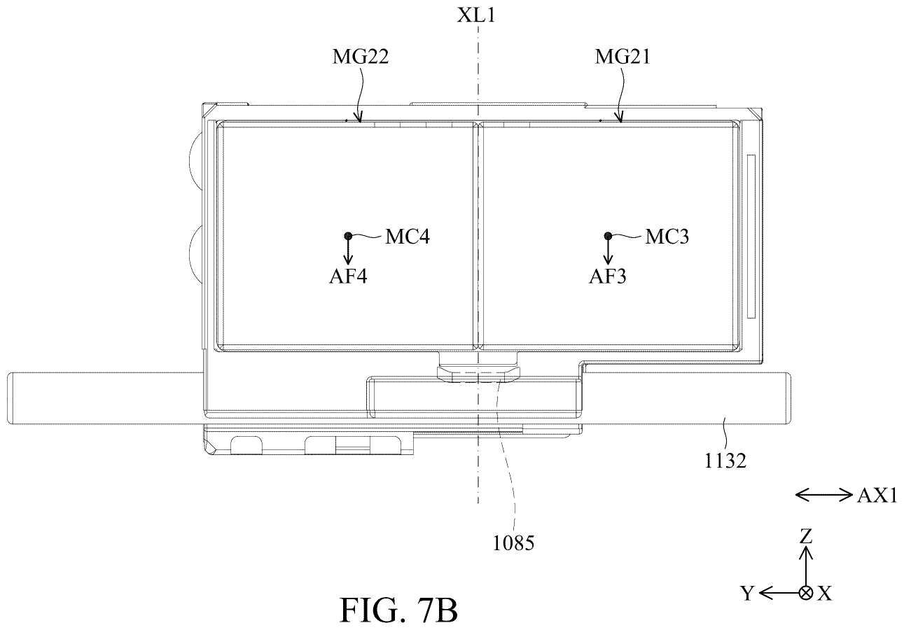

Next, please continue to refer to FIG. 5 to FIG. 7B. FIG. 6 is a side view of a partial structure of the optical element driving mechanism 100 according to an embodiment of the present disclosure, FIG. 7A is a side view of a partial structure of the optical element driving mechanism 100 in another view according to an embodiment of the present disclosure, and FIG. 7B is a side view of a partial structure of the optical element driving mechanism 100 in another view according to another embodiment of the present disclosure.

As shown in FIG. 6, in this embodiment, when viewed along the second axis AX2 (the X-axis), the size of the first magnetic element MG11 is different from the size of the second magnetic element MG12. Specifically, when viewed along the second axis AX2, the size of the second magnetic element MG12 is greater than the size of the first magnetic element MG11.

When viewed along the second axis AX2, the first magnetic element MG11 and the second magnetic element MG12 respectively have a first magnetic center MC1 and a second magnetic center MC2. When viewed along the second axis AX2, there is a first shortest distance MDS1 between the first magnetic center MC1 and the first guiding element 1131, and when viewed along the second axis AX2, there is a second shortest distance MDS2 between the second magnetic center MC2 and the first guiding element 1131.

In this embodiment, the second shortest distance MDS2 is different from the first shortest distance MDS1. Specifically, the second shortest distance MDS2 is less than the first shortest distance MDS1. Because the second magnetic element MG12 is greater in size, the second magnetic attraction force AF2 generated by the second magnetic element MG12 is greater than the first magnetic attraction force AF1 generated by the first magnetic element MG11.

During the movement of the movable part 108 along the first axis AX1, the movable part 108 may rotate around the first central connecting line CX1 or the third central connecting line CX3. For example, when the movable part 108 moves in a first direction DC1, the movable part 108 may rotate around the first central connecting line CX1 in a first rotation direction RD1, so that the second contact portion 1084 may be separated from the first guiding element 1131, thereby affecting the movement accuracy of the movable part 108.

Because the second magnetic attraction force AF2 of this embodiment is greater than the first magnetic attraction force AF1, and the projection of the second magnetic attraction force AF2 falls between the first contact portion 1083 and the second contact portion 1084, that is, falls on the second central connecting line CX2 (as shown in FIG. 5), the torque generated by the second magnetic attraction force AF2 relative to the first contact portion 1083 is greater than the torque generated by the first magnetic attraction force AF1 relative to the first contact portion 1083.

Therefore, the power of the second magnetic attraction force AF2 can be applied to the movable part 108 as a downward force to avoid the aforementioned problem that the movable part 108 may rotate around the first central connecting line CX1, thereby increasing the stability and accuracy of the movable part 108 during movement.

Similarly, as shown in FIG. 4 and FIG. 5, when the movable part 108 moves in a second direction DC2, the movable part 108 may rotate around the third central connecting line CX3 in a second rotation direction RD2, so that the first contact portion 1083 may be separated from the first guiding element 1131, thereby affecting the accuracy of the movement of the movable part 108. The second direction DC2 is opposite to the first direction DC1, and the second direction DC2 and the first direction DC1 are parallel to the first axis AX1.

Similarly, because the second magnetic attraction force AF2 is greater than the first magnetic attraction force AF1, the second magnetic attraction force AF2 can also serve as the downward force to avoid the problem that the movable part 108 may rotate around the third central connecting line CX3, thereby increasing the stability and accuracy of the movable part 108 during movement.

Next, as shown in FIG. 5 and FIG. 7A, the third magnetic element MG21 is adjacent to the fourth magnetic element MG22 at an interface surface XL1, the interface surface XL1 passes through the third contact center CC3, and when viewed along the main axis MX, the interface surface XL1 passes through the center of gravity WC1 of the optical element OE and the movable part 108. Based on such a structural configuration, the stability of the movable part 108 during movement can be increased.

In addition, as shown in FIG. 7A, the size of the fourth magnetic element MG22 is greater than the size of the third magnetic element MG21, and the fourth magnetic attraction force AF4 is greater than the third magnetic attraction force AF3. It should be noted that the difference in magnetic attraction force between the fourth magnetic attraction force AF4 and the third magnetic attraction force AF3 is different from the difference in magnetic attraction force between the second magnetic attraction force AF2 and the first magnetic attraction force AF1. Specifically, the difference in magnetic attraction force between the fourth magnetic attraction force AF4 and the third magnetic attraction force AF3 is less than the difference in magnetic attraction force between the second magnetic attraction force AF2 and the first magnetic attraction force AF1.

Alternatively, in other embodiments, as shown in FIG. 7B, the size of the fourth magnetic element MG22 is equal to the size of the third magnetic element MG21, and the fourth magnetic attraction force AF4 is equal to the third magnetic attraction force AF3. Therefore, the torque generated by the fourth magnetic attraction force AF4 relative to the third contact portion 1085 is equal to the torque generated by the third magnetic attraction force AF3 relative to the third contact portion 1085, so that the movable portion 108 does not rotate.

Based on such a structural configuration in FIG. 7A and FIG. 7B, the difference in magnetic attraction force between the fourth magnetic attraction force AF4 and the third magnetic attraction force AF3 does not cause the movable part 108 to rotate, so that the problem that the aforementioned movable part 108 may rotate around the first central connecting line CX1 or the third central connecting line CX3 can be further avoided.

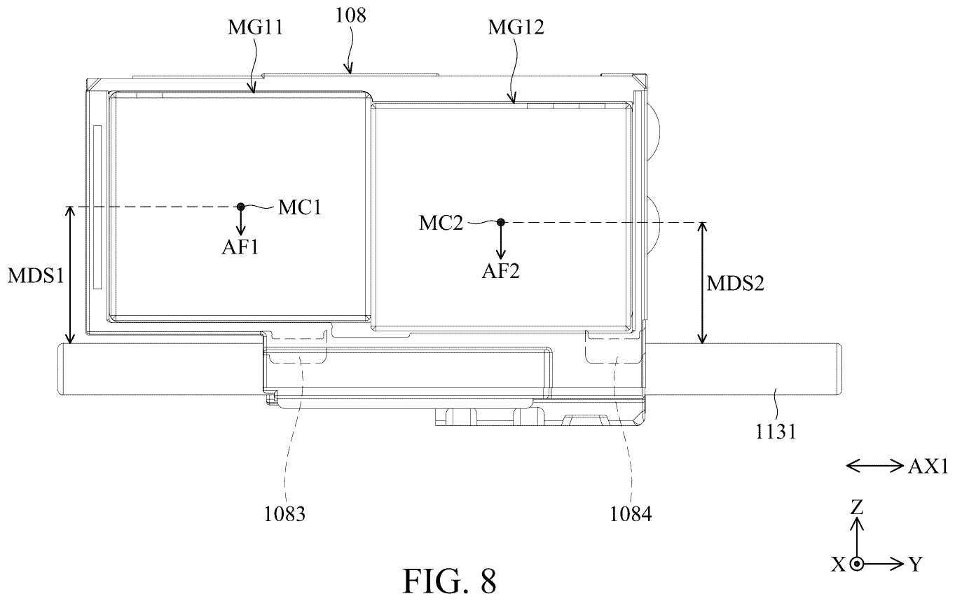

Please refer to FIG. 8. FIG. 8 is a side view of a partial structure of the optical element driving mechanism 100 according to another embodiment of the present disclosure. In this embodiment, when viewed along the second axis AX2, the size of the second magnetic element MG12 is equal to the size of the first magnetic element MG11. That is, the second magnetic element MG12 and the first magnetic element MG11 have the same area on the YZ plane.

Similarly, when viewed along the second axis AX2, the first magnetic element MG11 and the second magnetic element MG12 respectively have a first magnetic center MC1 and a second magnetic center MC2. When viewed along the second axis AX2, there is a first shortest distance MDS1 between the first magnetic center MC1 and the first guiding element 1131.

Similarly, when viewed along the second axis AX2, there is a second shortest distance MDS2 between the second magnetic center MC2 and the first guiding element 1131, and the second shortest distance MDS2 is different from the first shortest distance MDS1. Similar to the aforementioned embodiment, the second shortest distance MDS2 is less than the first shortest distance MDS1.

In addition, when viewed along the first axis AX1, a portion of the first magnetic element MG11 does not overlap a portion of the second magnetic element MG12. That is, the first magnetic center MC1 and the second magnetic center MC2 are not located on the same horizontal plane (such as the XY plane).

Therefore, based on such a configuration, because the second magnetic center MC2 is closer to the first guiding element 1131 than the first magnetic center MC1, the second magnetic attraction force AF2 is greater than the first magnetic attraction force AF1. Therefore, the second magnetic attraction force AF2 of this embodiment can also avoid the problem that the aforementioned movable part 108 rotates around the first central connecting line CX1 or the third central connecting line CX3 during movement.

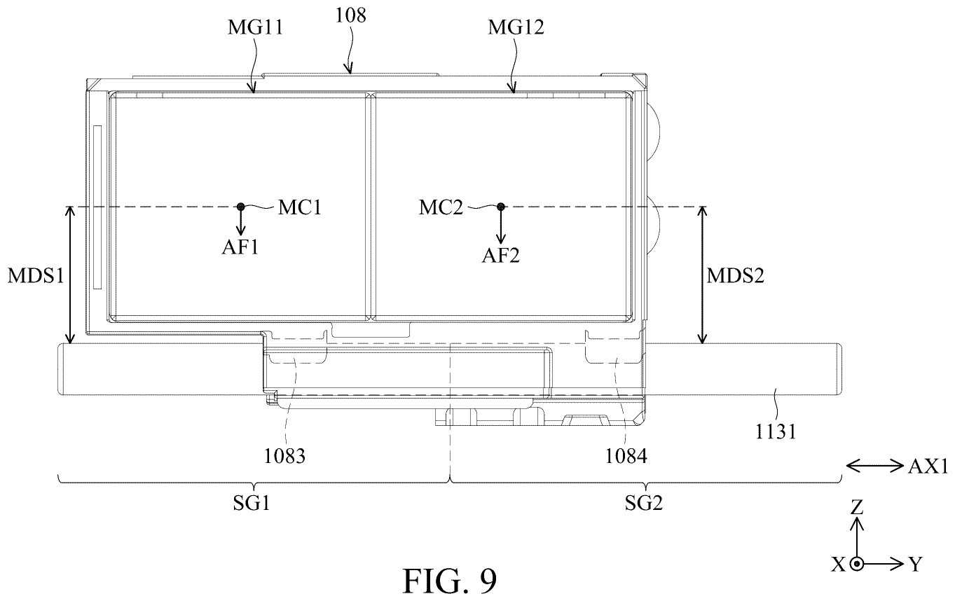

Please refer to FIG. 9. FIG. 9 is a side view of a partial structure of the optical element driving mechanism 100 according to another embodiment of the present disclosure. In this embodiment, when viewed along the second axis AX2, the size of the second magnetic element MG12 is equal to the size of the first magnetic element MG11.

Similarly, when viewed along the second axis AX2, the first magnetic element MG11 and the second magnetic element MG12 respectively have a first magnetic center MC1 and a second magnetic center MC2, and when viewed along the second axis AX2, there is a first shortest distance MDS1 between the first magnetic center MC1 and the first guiding element 1131.

Similarly, when viewed along the second axis AX2, there is a second shortest distance MDS2 between the second magnetic center MC2 and the first guiding element 1131, and the second shortest distance MDS2 is equal to the first shortest distance MDS1.

It is worth noting that, in this embodiment, the first guiding element 1131 may have a first section SG1 and a second section SG2, and the second section SG2 is connected to the first section SG1. The first section SG1 corresponds to the first magnetic element MG11, and the second section SG2 corresponds to the second magnetic element MG12. The lengths of the first section SG1 and the second section SG2 may be equal or different.

The magnetic permeability of the second section SG2 is greater than the magnetic permeability of the first section SG1. Based on such a configuration, although the second magnetic element MG12 and the first magnetic element MG11 have the same size and material, the second magnetic attraction force AF2 generated by the second magnetic element MG12 is still greater than the first magnetic attraction force AF1 generated by the first magnetic element MG11.

Therefore, the second magnetic attraction force AF2 of this embodiment can also avoid the problem that the aforementioned movable part 108 rotates around the first central connecting line CX1 or the third central connecting line CX3 during movement.

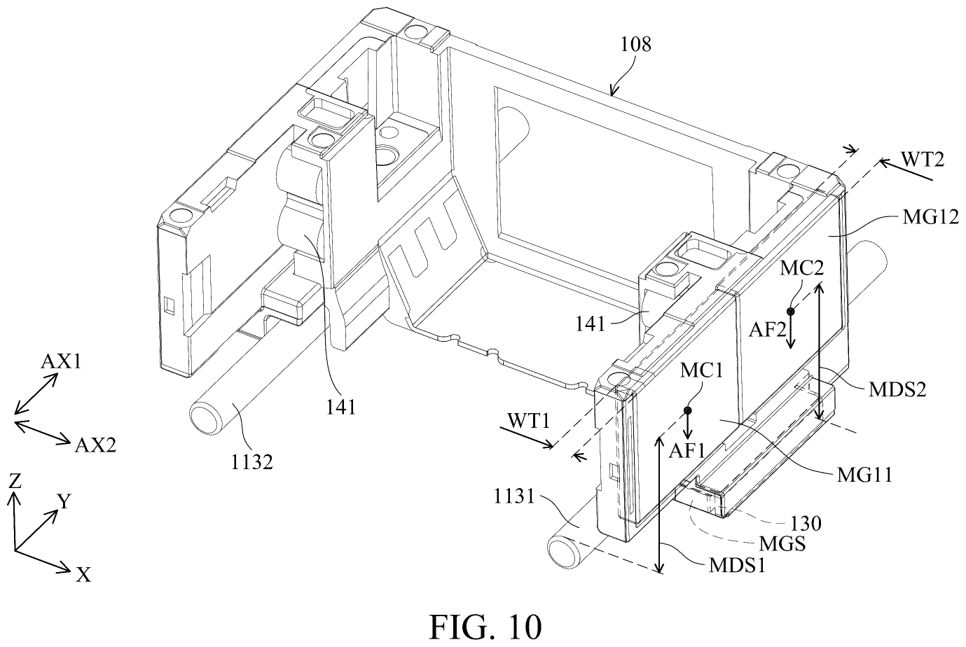

Please refer to FIG. 10. FIG. 10 is a perspective view of a partial structure of the optical element driving mechanism 100 according to another embodiment of the present disclosure. In this embodiment, when viewed along the second axis AX2, the size of the second magnetic element MG12 is equal to the size of the first magnetic element MG11. That is, the second magnetic element MG12 and the first magnetic element MG11 have the same area on the YZ plane.

Similarly, when viewed along the second axis AX2, the first magnetic element MG11 and the second magnetic element MG12 respectively have a first magnetic center MC1 and a second magnetic center MC2, and when viewed along the second axis AX2, there is a first shortest distance MDS1 between the first magnetic center MC1 and the first guiding element 1131.

Similarly, when viewed along the second axis AX2, there is a second shortest distance MDS2 between the second magnetic center MC2 and the first guiding element 1131, and the second shortest distance MDS2 is equal to the first shortest distance MDS1.

It is worth noting that when viewed along the main axis MX (the Z-axis), the first magnetic element MG11 has a first thickness WT1 on the second axis AX2, and when viewed along the main axis MX, the second magnetic element MG12 has a second thickness WT2 on the second axis AX2. The second thickness WT2 is greater than the first thickness WT1.

Based on such a configuration, the second magnetic attraction force AF2 generated by the second magnetic element MG12 is also greater than the first magnetic attraction force AF1 generated by the first magnetic element MG11. Therefore, the second magnetic attraction force AF2 of this embodiment can also avoid the problem that the aforementioned movable part 108 rotates around the first central connecting line CX1 or the third central connecting line CX3 during movement.

Then please return to FIG. 2, FIG. 4 and FIG. 5. In the present disclosure, the optical element driving mechanism 100 may further include a fifth magnetic element MG3 and a magnetic conductive plate 120, and the movable part 108 may further include a first groove RG1 configured to accommodate the fifth magnetic element MG3. The magnetic conductive plate 120 is disposed on the base 112 and located between the first side SS1 and the second side SS2.

Based on such a configuration, the fifth magnetic element MG3 can act with the magnetic conductive plate 120 to generate a fifth magnetic attraction force AF5 to increase the downward force on the movable part 108, thereby avoiding the problem of the movable part 108 rotating around the first central connecting line CX1 or the third central connecting line CX3 during movement.

It is worth noting that, when viewed along the main axis MX, the first groove RG1 is closer to the first guiding element 1131 than the second guiding element 1132, and when viewed along the main axis MX, the first groove RG1 is closer to the second contact portion 1084 than the first contact portion 1083.

Specifically, as shown in FIG. 5, when viewed along the main axis MX, the fifth magnetic element MG3 is located inside the aforementioned triangle. Based on such a configuration, the fifth magnetic attraction force AF5 can effectively press down the movable part 108 to avoid the problem of the movable part 108 rotating during the movement.

In addition, as shown in FIG. 2, the optical element driving mechanism 100 may further include a light-shading element 116, and the light-shading element 116 is disposed between the movable part 108 and the magnetic conductive plate 120. The light-shading element 116 is made of a material that absorbs light, such as a black light-absorbing film or black polyurethane, but it is not limited thereto. Based on the configuration of the light-shading element 116, it can prevent light leakage from affecting the imaging quality of the optical element driving mechanism 100.

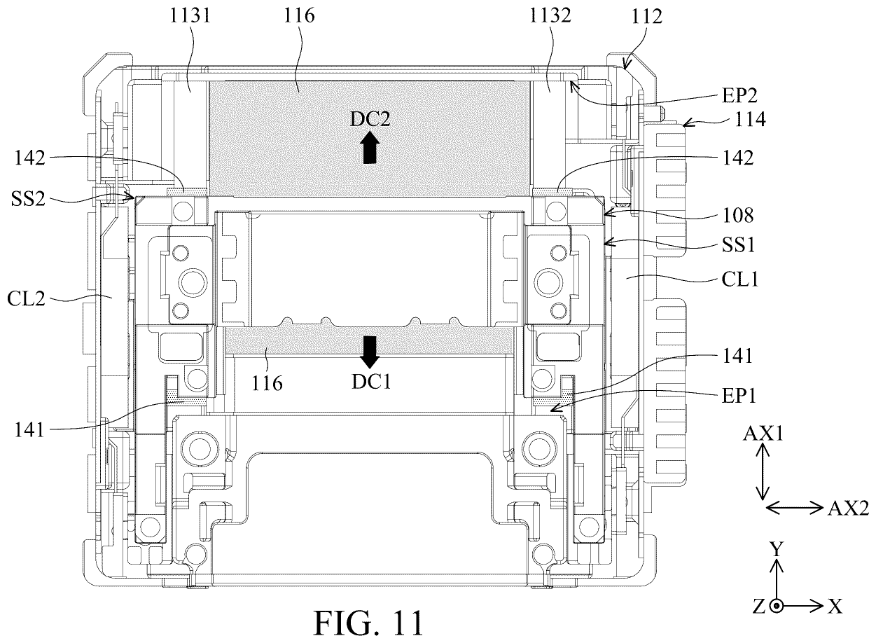

Please refer to FIG. 2 and FIG. 11. FIG. 11 is a top view of a partial structure of the optical element driving mechanism 100 according to an embodiment of the present disclosure. In this embodiment, the optical element driving mechanism 100 may further include two first buffering elements 141 and two second buffering elements 142 which are disposed on the movable part 108.

The two first buffering elements 141 and the two second buffering elements 142 are arranged along the first axis AX1, and the first buffering elements 141 and the second buffering elements 142 can be made of elastic material. For example, they may be made of rubber material, but they are not limited thereto.

As shown in FIG. 11, when the movable part 108 is driven to move downward in the first direction DC1 to a first extreme position EP1, the first buffering elements 141 are configured to contact a portion of the base 112, so that the movable part 108 is stopped at the first extreme position EP1.

Similarly, when the movable part 108 is driven to move upward in the second direction DC2 to a second extreme position EP2, the second buffering elements 142 are configured to contact another portion of the base 112, so that the movable part 108 is stopped at the second extreme position EP2.

Based on the configuration of the first buffering elements 141 and the second buffering elements 142, it can be ensured that the movable part 108 is not damaged due to collision when moving along the first axis AX1, and it can also avoid that particles generated by collision affect the image quality.

The present disclosure provides an optical element driving mechanism 100, which may include a movable part 108, a guiding assembly GA and a driving assembly DA. The guiding assembly GA may have a first guiding element 1131 and a second guiding element 1132 which are configured to guide the movable part 108 to move along the first axis AX1. The first contact portion 1083 and the second contact portion 1084 of the movable part 108 are configured to contact the first guiding element 1131, and the third contact portion 1085 of the movable part 108 is configured to contact the second guiding element 1132.

The first contact portion 1083 and the third contact portion 1085 can define a first central connecting line CX1, and the second contact portion 1084 and the third contact portion 1085 can define a third central connecting line CX3. During the movement of the movable part 108 along the first axis AX1, the movable part 108 may rotate around the first central connecting line CX1 or the third central connecting line CX3.

In order to avoid the occurrence of the above-mentioned problem, based on the configuration of the present disclosure, in the driving assembly DA, the second magnetic attraction force AF2 generated by the second magnetic element MG12 is greater than the first magnetic attraction force AF1 generated by the first magnetic element MG11, thereby providing a sufficient downward force to the movable part 108. Thus, this downward force can avoid the problem that the movable part 108 may rotate around the first central connecting line CX1 or the third central connecting line CX3, and this downward force does not affect the movement of the movable part 108, thereby increasing the stability and accuracy of the movable part 108 during movement.

Although the embodiments and their advantages have been described in detail, it should be understood that various changes, substitutions, and alterations can be made herein without departing from the spirit and scope of the embodiments as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein can be utilized according to the disclosure. Accordingly, the appended claims are intended to include within their scope such processes, machines, manufacture, compositions of matter, means, methods, or steps. In addition, each claim constitutes a separate embodiment, and the combination of various claims and embodiments are within the scope of the disclosure.

What is claimed is:

1. An optical element driving mechanism, comprising:
a fixed assembly;
a movable part, configured to be connected to an optical element, wherein the movable part is movable relative to the fixed assembly;
a driving assembly, configured to drive the movable part to move relative to the fixed assembly; and
wherein the fixed assembly includes an accommodating space configured to accommodate the optical element.

2. The optical element driving mechanism as claimed in claim 1, wherein
the fixed assembly has an outer cover and a base;
the outer cover is fixedly connected to the base along a main axis to form the accommodating space;
the optical element driving mechanism further includes a guiding assembly which is configured to guide the movable part to move along a first axis;
the first axis is perpendicular to the main axis;
the guiding assembly has a first guiding element and a second guiding element, which extend along the first axis and are configured to guide the movable part;
when viewed along the main axis, the first guiding element and the second guiding element are respectively located at a first side and a second side of the movable part;
when viewed along the main axis, the first guiding element and the second guiding element are arranged along a second axis;
the second axis is perpendicular to the first axis.

3. The optical element driving mechanism as claimed in claim 2, wherein
the movable part has a first guiding groove and a second guiding groove, which are configured to respectively accommodate the first guiding element and the second guiding element;
when viewed along the first axis, the first guiding groove has a V-shaped structure, and the first guiding element has a circular structure;
when viewed along the first axis, the second guiding groove has a U-shaped structure, and the second guiding element has a circular structure.

4. The optical element driving mechanism as claimed in claim 3, wherein
the movable part further has a first contact portion and a second contact portion, which are disposed in the first guiding groove;
the first contact portion and the second contact portion are configured to be in contact with the first guiding element;
the movable part further includes a third contact portion, which is disposed in the second guiding groove;
the third contact portion is configured to be in contact with the second guiding element.

5. The optical element driving mechanism as claimed in claim 4, wherein
the first contact portion defines a first contact center, the second contact portion defines a second contact center, and the third contact portion defines a third contact center;
when viewed along the main axis, the first contact center and the third contact center define a first central connecting line, which is neither parallel nor perpendicular to the first axis;
when viewed along the main axis, the first contact center and the second contact center define a second central connecting line, which is parallel to the first axis;
when viewed along the main axis, the third contact center and the second contact center define a third central connecting line, which is neither parallel nor perpendicular to the first axis;
when viewed along the main axis, the first contact center, the second contact center, and the third contact center together form a triangle;
the triangle is a non-isosceles triangle.

6. The optical element driving mechanism as claimed in claim 5, wherein
the driving assembly includes a first magnetic element, a second magnetic element and a first coil;
the first magnetic element and the second magnetic element are disposed on the movable part and are located at the first side;
the first coil is disposed on the base and corresponds to the first magnetic element and the second magnetic element;
the driving assembly further includes a third magnetic element, a fourth magnetic element and a second coil;
the third magnetic element and the fourth magnetic element are disposed on the movable part and are located at the second side;
the second coil is disposed on the base and corresponds to the third magnetic element and the fourth magnetic element;
the first guiding element and the second guiding element are made of magnetic conductive material.

7. The optical element driving mechanism as claimed in claim 6, wherein
the first magnetic element and the second magnetic element are configured to act with the first guiding element to respectively generate a first magnetic attraction force and a second magnetic attraction force;
when viewed along the main axis, the first magnetic attraction force and the second magnetic attraction force are located on opposite sides of the first contact center;
the third magnetic element and the fourth magnetic element are configured to act with the second guiding element to respectively generate a third magnetic attraction force and a fourth magnetic attraction force;
when viewed along the main axis, the third magnetic attraction force and the fourth magnetic attraction force are located on opposite sides of the third contact center.

8. The optical element driving mechanism as claimed in claim 7, wherein
a projection of the second magnetic attraction force along the second axis falls on the second central connecting line;
a projection of the first magnetic attraction force along the second axis does not fall on the second central connecting line;
the second magnetic attraction force is greater than the first magnetic attraction force.

9. The optical element driving mechanism as claimed in claim 7, wherein
a difference in magnetic attraction force between the fourth magnetic attraction and the third magnetic attraction is different from a difference in magnetic attraction force between the second magnetic attraction and the first magnetic attraction.

10. The optical element driving mechanism as claimed in claim 9, wherein
the difference in magnetic attraction force between the fourth magnetic attraction and the third magnetic attraction is less than the difference in magnetic attraction force between the second magnetic attraction and the first magnetic attraction.

11. The optical element driving mechanism as claimed in claim 7, wherein
when viewed along the second axis, a size of the first magnetic element is different from a size of the second magnetic element;
when viewed along the second axis, the size of the second magnetic element is greater than the size of the first magnetic element;
when viewed along the second axis, the first magnetic element and the second magnetic element respectively have a first magnetic center and a second magnetic center;
when viewed along the second axis, there is a first shortest distance between the first magnetic center and the first guiding element;
when viewed along the second axis, there is a second shortest distance between the second magnetic center and the first guiding element;
the second shortest distance is different from the first shortest distance;
the second shortest distance is less than the first shortest distance.

12. The optical element driving mechanism as claimed in claim 7, wherein
when viewed along the second axis, a size of the second magnetic element is equal to a size of the first magnetic element;
when viewed along the second axis, the first magnetic element and the second magnetic element respectively have a first magnetic center and a second magnetic center;
when viewed along the second axis, there is a first shortest distance between the first magnetic center and the first guiding element;
when viewed along the second axis, there is a second shortest distance between the second magnetic center and the first guiding element;
the second shortest distance is different from the first shortest distance;
the second shortest distance is less than the first shortest distance;
when viewed along the first axis, a portion of the first magnetic element does not overlap a portion of the second magnetic element.

13. The optical element driving mechanism as claimed in claim 7, wherein
when viewed along the second axis, a size of the second magnetic element is equal to a size of the first magnetic element;
when viewed along the second axis, the first magnetic element and the second magnetic element respectively have a first magnetic center and a second magnetic center;
when viewed along the second axis, there is a first shortest distance between the first magnetic center and the first guiding element;
when viewed along the second axis, there is a second shortest distance between the second magnetic center and the first guiding element;
the second shortest distance is equal to the first shortest distance;
when viewed along the main axis, the first magnetic element has a first thickness on the second axis;
when viewed along the main axis, the second magnetic element has a second thickness on the second axis;
the second thickness is greater than the first thickness.

14. The optical element driving mechanism as claimed in claim 7, wherein
when viewed along the second axis, a size of the second magnetic element is equal to a size of the first magnetic element;
when viewed along the second axis, the first magnetic element and the second magnetic element respectively have a first magnetic center and a second magnetic center;
when viewed along the second axis, there is a first shortest distance between the first magnetic center and the first guiding element;
when viewed along the second axis, there is a second shortest distance between the second magnetic center and the first guiding element;
the second shortest distance is equal to the first shortest distance;
the first guiding element has a first section and a second section;
the second section is connected to the first section;
the first section corresponds to the first magnetic element;
the second section corresponds to the second magnetic element;
a magnetic permeability of the second section is greater than a magnetic permeability of the first section.

15. The optical element driving mechanism as claimed in claim 7, wherein
the optical element driving mechanism further comprises a fifth magnetic element and a magnetic conductive plate;
the movable part further comprises a first groove configured to accommodate the fifth magnetic element;
the magnetic conductive plate is disposed on the base and located between the first side and the second side;
the fifth magnetic element is configured to act with the magnetic conductive plate to generate a fifth magnetic attraction force;
when viewed along the main axis, the first groove is closer to the first guiding element than the second guiding element;
when viewed along the main axis, the first groove is closer to the second contact portion than the first contact portion;
when viewed along the main axis, the fifth magnetic element is located inside the triangle.

16. The optical element driving mechanism as claimed in claim 15, wherein
the third magnetic element is adjacent to the fourth magnetic element at an interface surface;
the interface surface passes through the third contact center;
when viewed along the main axis, the interface surface passes through a center of gravity of the optical element and the movable part.

17. The optical element driving mechanism as claimed in claim 16, wherein
the optical element driving mechanism further includes a circuit assembly and a light-shading element;
the circuit assembly is disposed on the base;
the first coil and the second coil are configured to be electrically connected to the circuit assembly;
the light-shading element is disposed between the movable part and the magnetic conductive plate;
the light-shading element is made of a material that absorbs light.

18. The optical element driving mechanism as claimed in claim 17, wherein
the optical element driving mechanism further includes a first sensing element and a sensing magnet;
the first sensing element and the sensing magnet are respectively disposed on the circuit assembly and the movable part.

19. The optical element driving mechanism as claimed in claim 18, wherein
the optical element driving mechanism further includes a protective element which is disposed between the movable part and the sensing magnet;
the protective element is configured to cover a portion of the sensing magnet;
when viewed along the main axis, the protective element has an L-shaped structure.

20. The optical element driving mechanism as claimed in claim 2, wherein
the optical element driving mechanism further includes a first buffering element and a second buffering element which are disposed on the movable part;
the first buffering element and the second buffering element are arranged along the first axis;
when the movable part is driven to move to a first extreme position, the first buffering element is configured to contact the base;
when the movable part is driven to move to a second extreme position, the second buffering element is configured to contact the base.
